(19) United States
(12) Patent Application Publication
(10) Pub. No.: US 2024/0109928 A1
(43) Pub. Date: Apr. 4, 2024

(54) CHELATOR-MEDIATED FENTON (CMF) PROCESSES TO MODIFY LIGNIN

(71) Applicant: NATIONAL TECHNOLOGY & ENGINEERING SOLUTIONS OF SANDIA, LLC, Albuquerque, NM (US)

(72) Inventor: Michael S. KENT, Albuquerque, NM (US)

(21) Appl. No.: 18/483,617

(22) Filed: Oct. 10, 2023

Related U.S. Application Data
(63) Continuation of application No. PCT/US2022/024293, filed on Apr. 11, 2022.
(60) Provisional application No. 63/173,478, filed on Apr. 11, 2021.

(51) Int. Cl. C07G 1/00; C05F 11/00

(52) U.S. Cl. CPC C07G 1/00; C05F 11/00

(57) ABSTRACT

The present invention provides for a method to convert water-insoluble lignin into water-soluble polyacid, the method comprising: (a) contacting a chelator/Fe complex with a water-insoluble lignin to produce a reaction mixture, (b) introducing an oxidizing agent to the reaction mixture, (c) incubating the reaction mixture for a suitable period of time, (d) introducing further water-insoluble lignin to the reaction mixture during step (c); (e) introducing further oxidizing agent to the reaction mixture incubating step (c); and (f) optionally repeating step (d) and/or step (e) one or more times; such that at least about 90% of the water-insoluble lignin in the reaction mixture is converted into a water-soluble polyacid by the opening of at least one aromatic ring in each water-insoluble lignin.

### CROSS-REFERENCE TO RELATED APPLICATIONS

This application claims priority as a continuation application to PCT International Application No. PCT/US2022/024293, filed Apr. 11, 2022, which claims priority to U.S. Provisional Patent Application Ser. No. 63/173,478, filed on Apr. 11, 2021, both of which are hereby incorporated by reference.

### STATEMENT OF GOVERNMENTAL SUPPORT

The invention was made with government support under Contract Nos. DE-AC02-05CH11231 awarded by the U.S. Department of Energy. The government has certain rights in the invention.

### FIELD OF THE INVENTION

The present invention is in the field of modification of lignin.

### BACKGROUND OF THE INVENTION

Lignin constitutes about 15-30% of the dry weight of plant biomass and is comprised mostly of three monolignols that are polymerized through a variety of interunit C—C and C—O linkages in an irregular fashion. Lignin provides structural integrity to the plant cell walls, and consequently is highly resistant to breakdown. The residual lignin (20-30 wt % of the initial biomass) obtained after pretreatment is often overlooked as byproduct and in the paper and pulp industry and typically used for waste heat production. As such, removing, altering, or depolymerizing lignin is critical to lignocellulosic biomass-based industries. The structure of lignin suggests that it can be a valuable source of chemicals, particularly phenolics. Generating value from lignin has the potential to contribute significantly to the overall economic viability of a lignocellulosic biorefinery.

There is a need for a means to break down high molecular weight, water-insoluble lignin into fragments that can be readily upgraded into fuels or chemicals. Methods to date that achieve lignin breakdown to water soluble products have been reviewed elsewhere (Zakzewski et al., 2010; Pandey et al., 2011; Wang et al., 2013), but include hot alkaline treatment (Linger, et al., 2014) and a recently reported combination of oxidation in alkaline hydrogen peroxide followed by treatment in formic acid/sodium formate solution at 110° C. (Rahimi et al., 2014). The latter resulted in 52% of the original lignin converted to well-defined aromatic compounds. Treatment of unoxidized lignin in the formic acid/sodium formate solution at 110° C. resulted in a conversion of only 7%. Another current method involves lignin pretreatment and depolymerization requiring sulfuric acid or alkali under much high temperature (such as 180° C.), which results in the main disadvantages of high-energy consumption and waste emission. Development of a simple, efficient and economic route to dissolve and depolymerize lignin is still a challenge.

U.S. Patent Application Publication No. 2019/0002490 (Michael Kent) discloses a method to modify a lignin comprising: (a) mixing a lignin, a chelator, and FeCl₃ to produce a first solution, (b) optionally incubating the solution for a first suitable period of time, (c) introducing an oxidizing agent to the first solution to produce a second solution, and (d) optionally incubating the solution for a second suitable period of time; such that at least one aromatic ring of one lignin polymer is opened.

Recent studies (Engineering 2016, vol. 2, p. 270) have demonstrated soilization of desert lands through addition of the water-soluble polymer carboxymethylcellulose (CMC). The report claims that CMC promotes water retention and also favorably alters the mechanical properties through formation of a highly viscous paste. Other recent studies (J. Plant Nutr. Soil Sci. 2018, vol. 181, p. 211; Plant and Soil 2005, vol. 271, p. 243) have shown that lignosulfonates (LS) and biochar as soil amendments improve plant growth by promoting the growth of arbuscular mycorrhizal fungi (AMF) and by increasing the availability of nitrogen and phosphorus supplied by fertilizers. However, no such studies have yet been reported for lignin material derived from lignocellulosic biomass conversion processes.

### SUMMARY OF THE INVENTION

The present invention provides for a method to convert water-insoluble lignin into water-soluble polyacid, the method comprising: (a) contacting a chelator/Fe complex with a water-insoluble lignin to produce a reaction mixture, (b) introducing an oxidizing agent to the reaction mixture, (c) incubating the reaction mixture for a suitable period of time, (d) introducing further water-insoluble lignin to the reaction mixture during step (c); (e) introducing further oxidizing agent to the reaction mixture incubating step (c); and (f) optionally repeating step (d) and/or step (e) one or more times; such that at least about 90% of the water-insoluble lignin in the reaction mixture is converted into a water-soluble polyacid by the opening of at least one aromatic ring in each water-insoluble lignin.

In some embodiments, the method further comprises: contacting a Fe salt and a chelator to form the chelator/Fe complex. In some embodiments, the contacting a Fe salt and a chelator step occurs prior to concurrently with contacting step (a). In some embodiments, the chelator/Fe complex is formed by the contacting a Fe(III) salt with a chelator.

In some embodiments, the chelator is 1,2-dihydroxybenzene (DHB). In some embodiments, the initial chelator concentration in the reaction can be equal to or less than, or at least, about 35 mM, 40 mM, 45 mM, 50 mM, or 55 mM.

In some embodiments, the Fe salt is any Fe(II) salt or Fe(III) salt, such as FeX₃, (wherein X is any halide, such as F, Cl, Br, or I), Fe₂(SO₄)₃, Fe(NO₃)₃, or the like. In some embodiments, the Fe salt is iron (II) perchlorate (Fe(ClO₄)₂), iron(II) phosphate (FePO₄), iron(III) pyrophosphate (Fe₄(P₂O₇)₃), iron(II) pyrophosphate, iron(II) sulfate (FeSO₄), ammonium iron(II) sulfate, iron(II) bromide, iron(III) bromide, iron(II) chloride, iron(III) chloride, iron(II) fluoride, iron(III) fluoride, iron(III) nitrate, iron(II) oxalate, iron(III) oxalate, or a hydrate thereof, or a mixture thereof. In some embodiments, the Fe salt contains has at least 99.9%, 99.99%, or 99.999% purity trace metal basis. In some embodiments, the initial Fe ion concentration in the reaction can be equal to or less than, or at least, about 30 mM, 35 mM, 40 mM, 45 mM, or 50 mM.

In some embodiments, the polyacid comprises at least two carboxylic functional groups. In some embodiments, the chelator is any chelator that can chelate Fe to facilitate the reduction of Fe(III) to Fe(II). The chelator/Fe complex is formed by the contact of a Fe salt and a chelator. In some embodiments, the chelator is 1,2-dihydroxybenzene (DHB), 2,3-dihydroxybenzoic acid (DHBA), pyrogallol, or a mixture thereof.

In some embodiments, the method results in at least about 91%, 92%, 93%, 94%, 95%, 96%, 97%, 98%, 99%, 99.5%, or 99.9%, or essentially about 100% of the water-insoluble lignin in the reaction mixture is converted into a water-soluble polyacid.

In some embodiments, the method lacks a concentration step and/or separating step.

In some embodiments, the water-insoluble lignin is part of a solid component that is equal to or more than about 15%, 20%, 25%, or 30% by weight of the reaction mixture. In some embodiments, the water-insoluble lignin is part of a solid component that is equal to or more than about 25%, 30%, 35%, 40%, 45%, or 50% by weight of the first solution. In some embodiments, the solid component is a biomass.

In some embodiments, the introducing step (d), introducing step (e), and/or repeating step (f) are continuous or semi-continuous.

In some embodiments, the method further comprises: (g) introducing a base to the reaction mixture to adjust the pH of the reaction mixture to about pH 3.0 to 6.0, and (h) optionally repeating step (g) one or more times. In some embodiments, the introducing step (g) and repeating step (h) are continuous or semi-continuous.

In some embodiments, the introducing step (g), and optionally repeating step (h), adjust the pH of the reaction mixture to about pH 3.0, 3.5, 4.0, 4.5, 5.0, 5.5, or 6.0, or any value within any of the preceding two values.

The method of claim 1, further comprising: (i) heating the reaction mixture to a temperature of about 40° C. to 60° C. or to about 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., or 60° C., or any value within any of the preceding two values.

In some embodiments, the suitable period of time is at least about 1, 2, 3, 4, 5, 6, or 7 days.

In some embodiments, the incubating step (c) takes place at a temperature of about room temperature or 25° C.

In some embodiments, the method results in a mixture of lignin polymers comprising more than one polymer wherein each polymer has at least one aromatic ring opened, wherein optionally each polymer has the opened aromatic ring on a different part of each polymer.

In some embodiments, the introducing step (b) and/or introducing step (e) comprise bubbling a gas composition comprising O₂ into the reaction mixture. In some embodiments, the gas composition comprises at least about 20% of O₂. In some embodiments, the gas composition comprises essentially 100% of O₂. In some embodiments, the oxidizing agent is H₂O₂ or molecular oxygen (O₂), or both. In some embodiments, the oxidizing agent is added at a rate of about (1) 0.2% (by weight) every 15 minutes, or (2) 0.4 mL per 15 minutes for each 200 mL of reaction mixture.

In some embodiments, the gas composition is bubbled through the reaction mixture at a rate of at least about 0.01 standard cubic feet per hour (SCFH). In some embodiments, the gas composition is bubbled through the reaction mixture at a rate of at least about 0.05 standard cubic feet per hour (SCFH). In some embodiments, the introducing step (b) and/or introducing step (e) result in at least about 0.1%, 0.2%, 0.3%, 0.4%, or 0.5%, or any value within any of the preceding two values, of [oxidizing agent]₀.

The present invention provides for a method for using a mixture of the present invention, or a mixture of modified lignin produced by the methods taught in U.S. Patent Application Publication No. 2019/0002490 (Michael Kent) (which is hereby incorporated by reference in its entirety), for soilizing agent or a soil amendment. The present invention provides for a method for providing nutrients to a plant or plant substrate, the method comprising: introducing a mixture of modified lignin comprising a lignin with at least one aromatic ring opened to form a polyacid to soil, sand, or substrate for plants, or mixture thereof, to form an enhanced substrate composition. In some embodiments, the substrate for plants comprises used coffee grounds.

In some embodiments, the method further comprises planting a seed or plant in the enhanced substrate composition, or adding the enhanced substrate composition to a cropland or soil, optionally planted or to be planted with a seed, plant, or crop. In some embodiments, the seed, plant, or crop comprises an ornamental, food, or forage crop.

The present invention provides for a method for increasing the molecular weight (MW) of lignosulfonate and/or lignin, the method comprising: (a) contacting a chelator/Fe complex with a lignosulfonate and/or lignin or a mixture thereof, to produce a reaction mixture, (b) incubating the reaction mixture for a suitable period of time, and (c) optionally introducing an oxidizing agent to the reaction mixture; such that the average molecular weight of the lignosulfonate and/or lignin in the reaction mixture is increased.

In some embodiments, the Fe concentration added to the reaction mixture has a concentration equal to or higher than about 10 mM, 15 mM, 20 mM, 25 mM, 30 mM, 35 mM, 40 mM, 45 mM, or 50 mM, or having a value within any two preceding values. In some embodiments, the concentration or chelator/Fe complex or Fe salt in the reaction mixture is increased by introducing more chelator/Fe complex or Fe salt to the reaction mixture. In some embodiments, introducing more chelator/Fe complex or Fe salt brings the total concentration of chelator/Fe complex or Fe salt to a concentration equal to or higher than about 10 mM, 15 mM, 20 mM, 25 mM, 30 mM, 35 mM, 40 mM, 45 mM, or 50 mM, or having a value within any two preceding values, in the reaction mixture. The high concentration of iron (10 mM or more) increases the average MW of lignosulfonate or lignin, or a mixture thereof.

In some embodiments, the adding or introducing of reactants, such as Fe, chelator/Fe complex, or oxidizing agent avoids, prevents, or does not cause high or increasing viscosity and/or foaming. In some embodiments, the adding or introducing of reactants, such as Fe, chelator/Fe complex, or oxidizing agent yields a hydrophilic polymer with less aromaticity and/or more carboxylic acid or COOH groups.

In some embodiments, the method results in the opening of one or more aromatic rings, adds COOH functionality and alters the molecular weight. In some embodiments, the method results a lower molecular weight of the lignin which improves bioavailability absent toxicity. The degree of sulfonation of the lignin affects the extent of modification. However, the degree of sulfonation may also contribute to toxicity. The amount of sulfonation can be varies in order to optimize for a higher or the highest bioavailability.

The present invention provides for a mixture of modified lignin, having (a) one or more water-insoluble lignin converted into a water-soluble polyacid by the opening of at least one aromatic ring in each water-insoluble lignin, and or (b) increased average MW of lignosulfonate or lignin, or a mixture thereof, produced by the method of the present invention. The present invention provides for any of the reaction mixtures described herein.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows the chemical structures of lignosulfonate.

FIG. 2 shows the indulin AT, method A versus method B. Indulin AT as received had a molecular weight 2,700 g/mol. The molecular weight increased by CMF.

FIG. 3 shows alkaline lignin, method A followed by method B. The molecular weight can be increased with CMF treatment at higher Fe concentration.

FIG. 4 shows lignosulfonates and Fenton reaction prior work by Areskogh and Henriksson (Nordic Pulp and Paper Research Journal, 26:90, 2011). Molecular weight is altered by lignin concentration.

FIG. 5A shows post-reaction Mw variation for CMF reactions of LS with [DHB]=4 mM, [H₂O₂]=1%, at room T as a function of [FeCl₃] ([LS]=5 mg/ml). The initial Mw was 28,000 g/mol and is shown by the dashed line.

FIG. 5B shows post-reaction Mw variation for CMF reactions of LS with [DHB]=4 mM, [H₂O₂]=1%, at room T as a function of [LS] ([FeCl₃]=10 mM). The initial Mw was 28,000 g/mol and is shown by the dashed line.

FIG. 6 shows the Fourier-transform infrared spectroscopy (FTIR) data from polyacid product after CMF.

FIG. 7 shows increasing the volume of H₂O₂ added increases the amount of ring opening.

FIG. 8 shows pH affects how increasing the volume of H₂O₂ added increases the molecule weight of the lignin sample tested.

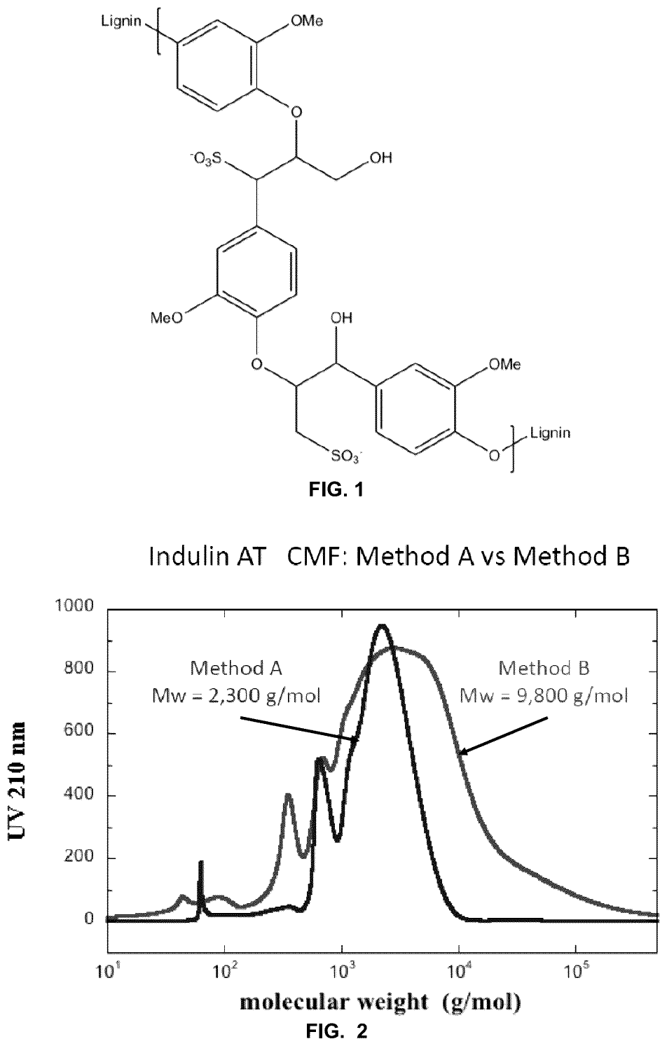

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only, and is not intended to be limiting.

In this specification and in the claims that follow, reference will be made to a number of terms that shall be defined to have the following meanings:

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The term “about” includes any value up to 10% less or 10% more inclusive of the value provided.

The term “lignin” also includes the meaning of a mixture of different lignin polymers.

Regarding reaction conditions for methods of the present invention, in one aspect of the invention, the method encompasses performing the reaction in a single batch to achieve high solids loading without separation or concentration. Due to the hydrophobicity of lignin, the viscosity could be prohibitively high at high lignin loadings. In some embodiments, high solids loading is achieved by sequential additions of lignin and H₂O₂, because as lignin is oxidized by the reaction it becomes more hydrophilic and the viscosity decreases. In another aspect of the invention, the reaction is optimized by maximizing the efficiency of H₂O₂ use, because that is one of the most expensive reagents. The efficiency of H₂O₂ use can be maximized when added a little at a time in the presence of a high concentration of lignin. In some embodiments, the condition required to achieve both high solids content and also high efficiency of H₂O₂ requires sequential additions of lignin and H₂O₂. The total amount of H₂O₂ determines how much oxidation occurs, and also determines the amount of COOH, OH, and aromatic functionalities in the final product. In another aspect of the invention, the MW of the final product can be increased by Fe concentration. In some embodiments, the final Mw can be tuned according to the amount of Fe added. DHB is added to reduce Fe(III) to Fe(II), as the Fenton reaction involves reaction of Fe(II) with H₂O₂. Lignin has some capacity to reduce Fe(III) to Fe(II), however, a chelator, such as DHB, needs to be added to efficiently use the H₂O₂. The reaction also has an optimal pH. In some embodiments, the pH is periodically adjusted (such as up to pH 6) during the reaction. The reaction rate is a strong function of temperature. Suitable temperatures include from room temperature up to 40° C.

In some embodiments, the concentration of lignin is about 15% to 25%. In some embodiments, the lignin is of a concentration that can mix well.

In some embodiments, Fe is added to a concentration that will result in the desired MW. A suitable range of concentration is from about 1 mM to about 90 mM, as are from about 1 mM to about 30 mM, from about 1 mM to about 50 mM, from about 5 mM to about 30 mM, from about 5 mM to about 50 mM, from about 5 mM to about 90 mM, from about 10 mM to about 30 mM, from about 10 mM to about 50 mM, and 10 mM to 90 mM.

In some embodiments, the total amount of H₂O₂ depends on the desired amount of COOH, OH, and aromatic functionalities in the final product. Suitable amounts of H₂O₂ to be used include from about 0.2 g H₂O₂ (pure basis)/g lignin to about 0.75 g H₂O₂ (pure basis)/g lignin.

In some embodiments, the H₂O₂ and additional lignin are added sequentially.

In some embodiments, the method comprises first adding 10% of the total H₂O₂ (which initiates the reaction), allowing the reaction to occur for about 30-60 min (the time depends on the temperature), adding additional lignin up to the point that the mixture can still be mixed well, adding another aliquot of H₂O₂, and so on until all the lignin and H₂O₂ have been added. The size of the aliquots of H₂O₂ and lignin can vary. In some embodiments, there is 10% of the total H₂O₂, followed by adding lignin to increase solids content by about 2-5%, and then repeating one or more additions. In some embodiments, to maximize the efficiency of H₂O₂ usage, the lignin concentration should be as high as possible and the H₂O₂ added in low amounts. In some embodiments, about 22-25% solids can be achieved. In some embodiments, about 30% solids can be achieved. In some embodiments, about 35% solids can be achieved. In some embodiments, about 40% solids can be achieved.

In some embodiments, the entire amount of DHB can be added at the start or incrementally along with the lignin and H₂O₂. In some embodiments, a suitable amount of DHB to be added is about 10 mg DHB/g lignin to about 20 mg DHB/g lignin.

In some embodiments, the optimal pH is between about 3 and 6. In some embodiments, the optimal pH is between about 4 and 5. So it must be maintained within that range.

In some embodiments, the aromatic ring opened by the present invention forms a polyacid as a result of the aromatic ring being opened. In some embodiments, the polyacid comprises two carboxylic functional groups. In some embodiments, the method results in a mixture of lignin polymers comprising more than one polymer wherein each polymer has at least one aromatic ring opened, wherein optionally each polymer has the opened aromatic ring on a different part of each polymer. In some embodiments, the lignin polymer with at least one aromatic ring opened is water-soluble. In some embodiments, water-soluble lignin polymer mixture produced by the method has an average molecular weight smaller than the average molecular weight of the lignin, or mixture of lignin, at the start of the method.

In some embodiments, the method results in at least about 1 mg, 5 mg, 10 mg, 15, mg, or 20 mg of water-insoluble lignin is converted into a water-soluble lignin from every 100 mg of water-insoluble lignin.

In some embodiments, the lignin is obtained from pretreatment of a biomass. In some embodiments, the lignin has a concentration of from about 1 mg/mL to about 100 mg/mL. In some embodiments, the lignin has a concentration of from about 1 mg/mL to about 50 mg/mL. In some embodiments, the chelator is 1,2-dihydroxybenzene (DUB) or 1,2-benzenediol, or any DHB further substituted with one or more hydroxyl groups, such as 1,2,3-trihydroxybenzene and 1,2,3,4-tetrahydroxybenzene. In some embodiments, the FeCl₃ has a concentration of from about 0.1 mM to about 10 mM. In some embodiments, the FeCl₃ has a concentration of from about 0.5 mM to about 4 or 5 mM. In some embodiments, the first suitable period of time and second suitable period of time is from about 24 hours to about 48 hours, optionally at about room temperature. In some embodiments, the H₂O₂ has a concentration of from about 0.1% to about 10% mg/mL. In some embodiments, the H₂O₂ has a concentration of from about 0.5% to about 5% mg/mL.

In some embodiments, the method comprises the following: Preparing an equimolar stock solution of the chelator and the Fe salt (such as 10 mM) in water. In some embodiments, the pH is at about pH 3. Allowing the solution to incubate at least 30 min results in the formation of chelator/Fe(III) complexes. In some embodiments, the stock solution is used to prepare a solution of 4 mM chelator/Fe(III) complexes in water at pH 3 containing lignin. Stirring the mixture vigorously for a minimum of several hours (such as overnight). Then adding hydrogen peroxide (H₂O₂) at 0.5% (5 mg/ml) and allow the reaction to proceed to completion. The time required for completion varies with the amount of lignin. This results in nearly complete conversion of the water-insoluble lignin into an aqueous solution of lignin breakdown products at pH 3. The product distribution (size and chemical nature of the lignin-derived molecular fragments) will vary with the amount of lignin used as well as with the reaction time. In some embodiments, the method comprises the use of 4 mM chelator, 4 mM Fe salt, 5 mg/ml H₂O₂, and lignin content ranging from 2.5 mg per ml of solution to 12.5 mg per ml of solution.

In one aspect of the present invention, the invention provides for a method for processing lignin with the chelator-mediated Fenton reaction to make polymer products wherein the method avoids separation and concentration steps. Commercially, avoiding the separation and concentration steps is crucial for economic viability.

In one aspect of the present invention, the invention provides for a modification to the CMF (Chelator Mediated Fenton) method disclosed by U.S. Patent Application Publication No. 2019/0002490 (Michael Kent) (which is hereby incorporated by reference in its entirety) by eliminating the need for the (i) separation and (ii) concentration steps. The CMF process transforms insoluble lignin into a water-soluble polymer by opening aromatic rings and generating carboxylic acid groups. The water-soluble lignin-derived polymer has potential uses as a dispersant, water-purification agent, water-adsorbing material, or soil amendment. The CMF process described in U.S. Patent Application Publication No. 2019/0002490 (Michael Kent) is a semi-batch process that may require one or more repeated centrifugation steps to separate the water-soluble polyacid product from the portion of lignin that remains insoluble at each reaction stage. In one aspect of the present invention, the method eliminates the need for this separation step by converting 100% of the lignin to product in a single batch. The CMF process described in U.S. Patent Application Publication No. 2019/0002490 (Michael Kent) also may require a concentration step as the process results in a polyacid product that is present in solution at roughly 4% solids. For many applications a separation or concentration step is required in order to avoid high shipping costs. In one aspect of the present invention, the method results in a product at over more than 20% solids, thus eliminating the need for a concentration step.

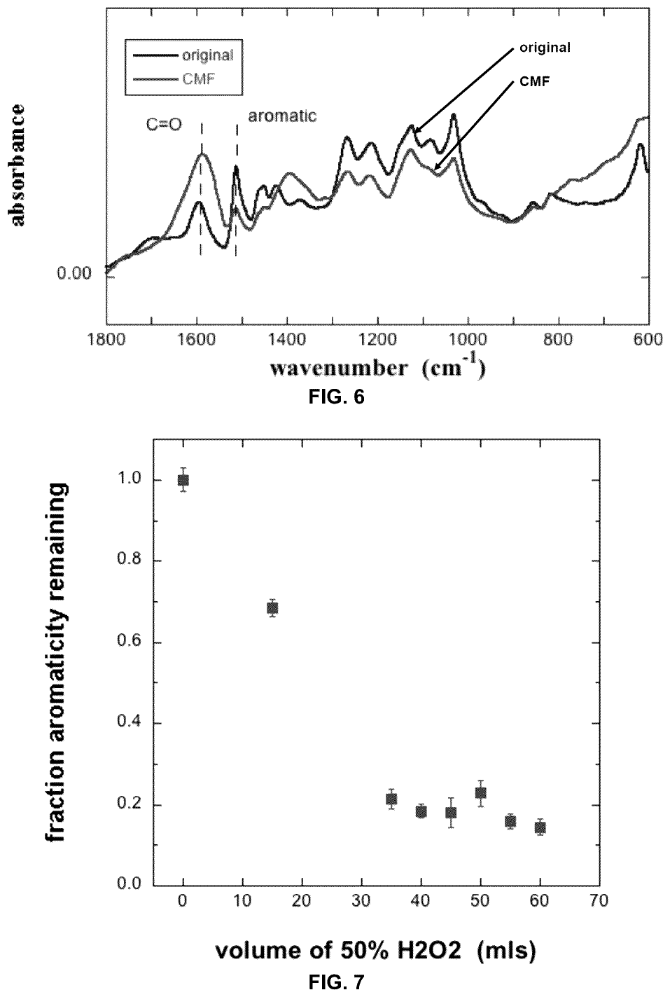

In one aspect of the present invention, the method achieves CMF in a single batch at high solids loading by continuous or semi-continuous addition of H₂O₂. In some embodiments, the method results in about 100% overall yield and 1.4 g polyacid per g H₂O₂ consumed. An example involves Indulin AT lignin. The batch reaction involved 31 g lignin process and the total amounts of H₂O₂, FeCl₃, and dihydroxybenzene (DHB) consumed are 22 g, 0.59 g, and 0.37 g respectively. The final product is present at 22% solids. In one aspect of the present invention, the method comprises a sequence of additions of lignin and reactants to achieve high lignin loading and yet retain the ability to mix throughout the process. As the reaction proceeds the mixture becomes less viscous. The process involves addition of 20 g of lignin, 108 mg FeCl₃ and 44 mg DHB, pH adjustment to 6.0, and then addition of 3.7 ml of 35% H₂O₂ for the initial reaction. Following this reaction, 11 g of lignin are added, pH is adjusted to 6.0 followed by successive additions of aliquots of 35% H₂O₂ totaling 18.4 ml. The pH drops as the reaction proceeds and acid (such as an inorganic acid, such as HCl) is added periodically to increase the pH to 6. Further successive additions of FeCl₃ and DHB are also performed during this stage to give the totals of 0.59 g, and 0.37 g respectively. The reactions described above can occur at room temperature. There can be a further step of heating to 50° C. over several days to dissipate any residual H₂O₂. While this method has important advantages in eliminating the need for separation and product concentration steps, only partial de-aromatization (about 70%) has been achieved. An example of such a result is shown in FIG. 6.

In one aspect of the present invention, the invention comprises the careful selection of reaction conditions, in particular the sequence of addition of the reactants, to achieve high extent of de-aromatization along with high solids content without a separation step or a product concentration step. This water-soluble lignin-derived polymer has potential uses as a dispersant, water-purification agent, water-adsorbing material, or soil amendment. The de-aromatized lignin has some advantages over current polyacrylic acid-based materials in that the CMF lignin could be produced at lower cost. This de-aromatized lignin has some advantages over lignosulfonates in that the process for generating CMF lignin generates less hazardous waste or pollutants than the processes used to produce lignosulfonates.

In one aspect of the present invention, the invention can produce lignin that is oxidized in a chelator-mediated Fenton (CMF) process that results in partial or complete de-aromatization. This modified lignin can be used for soilization of desert lands, wherein soil is created from sand or sand-like material in arid lands. This modified lignin can be used as a soil amendment by promoting the growth of arbuscular mycorrhizal fungi and by increasing the availability of nitrogen and phosphorus supplied by fertilizers. The end use of such products can be for agriculture.

It is expected that CMF lignin have similar soilization properties to CMC because the CMF process transforms lignin into a highly water-soluble polyacid material that forms a highly viscous paste, where the viscosity depends on concentration and molecular weight. By controlling reaction conditions, the amount of low molecular weight material can be minimized such that the majority of the material has molecular weight comparable to that of the original lignin. CMC is a synthetic polymer that is derived from cellulose. Since cellulose contains valuable sugars that are easily converted to fuels and chemicals whereas lignin is much more difficult to convert to fuels and chemicals, using material derived from lignin for soilization is a much better choice from an economic perspective. The second application is as a soil amendment. In the first application, the role of CMF lignin is to enhance the mechanical properties to create soil from sand and sand-like material that does not have the properties of soil. In the second application, the role of CMF lignin is to enhance soil by promoting the growth of AMF.

The products produced by the methods of the present invention are useful as: (1) soilizing agent—CMC is a synthetic polymer that is derived from cellulose. Since cellulose contains valuable sugars that are easily converted to fuels and chemicals whereas lignin is much more difficult to convert to fuels and chemicals, using material derived from lignin for soilization is a much better choice from an economic perspective. (2) soil enhancer—CMF lignin would enhance the growth of AMF and the performance of fertilizers and would be less expensive than other soil amendments.

The extent of de-aromatization and quantity of COOH groups, as produced by the methods of the present invention, can be measured by P31 NMR, 1H-13C HSQC NMR, FTIR, and NaOH titration.

In one aspect of the present invention, the invention encompasses a method to increase the molecular weight of lignosulfonates and other lignins. The MW of the polymer product can be increased significantly during the reaction by adjusting the Fe concentration using the methods of the present invention. Increasing the MW of lignin can add significant commercial value for some polymer applications. This approach to increase the MW works for both regular lignin and also for lignosulfonate. The molecular weights of other lignins can also be increased using the CMF reaction at high Fe concentration and high lignin concentration.

In some embodiments, the steps involved in the method to convert water-insoluble lignin into a water-soluble material with good dispersant properties are detailed below. The tests are performed using organosolv lignin from Lignol Corp. This material is largely insoluble in water (only about 3% by mass is soluble at pH 6).

In some embodiments: Prepare an equimolar stock solution of dihydroxybenzene (DHB) and FeCl₃ (typically 10 mM) in water at pH 6. Allow the solution to incubate at least 30 min to allow DHB/Fe(III) complexes to form. Use that stock solution to prepare a solution of 4 mM DHB/Fe(III) in water at pH 6 containing lignin at 400 mg/8 ml. Stir the mixture vigorously for 24 h. Then add sufficient hydrogen peroxide (H₂O₂) to make 0.5% (40 mg/8 ml) and allow the reaction to proceed for 48 h. This protocol results in solubilization of 20 mg of the water-insoluble lignin into an aqueous solution at pH 6.

In some embodiments, the product distribution (size and chemical nature of the lignin-derived molecular fragments) varies with the amount of lignin used as well as with the reaction time. GPC results are obtained for one series of reactions involving 4 mM DHB, 4 mM, FeCl₃, 40 mg H₂O₂/8 ml, and lignin content ranging from 2.5 mg per ml of solution to 12.5 mg per ml of solution. Reaction time is 48 h. The results show that most of the water-soluble material is comprised of polymeric fragments with MW only slightly less than that of the original material.

In a particular embodiment, the method uses Fenton chemistry (FeCl₂+H₂O₂) and chelator-mediated Fenton chemistry (FeCl₃+DHB+H₂O₂) at the appropriate level of severity to generate hydroxyl radical that preferentially adds to aromatic rings and, under appropriate conditions, leading to opening of aromatic rings to yield polyacids that function as effective dispersants. Reactions conditions must be controlled properly to obtain partially oxidized high MW ring-opened fragments. Another aspect is to control the extent of ring opening, and therefore the relative amounts of hydrophobic and charged groups that strongly impact the effectiveness of a dispersant, through the reaction conditions. A third aspect is to control the reaction conditions to maximize the production of solubilized lignin material per amount of H₂O₂ used. Important reaction conditions that affect the amount of H₂O₂ required include mass of lignin per volume, pH, the use and choice of an Fe-chelator that associates with lignin and will reduce Fe(III) to Fe(II), order of addition of the reactants (combining FeCl₃ and DHB and lignin and mixing the dispersion extensively prior to addition of H₂O₂), and the amount of H₂O₂ used.

The chemical reaction described above is a variation of the classic Fenton reaction involving H₂O₂ and FeCl₂ that has been known for many years and has been studied with respect to breakdown of lignin (Araujo et al, 2002) and breakdown of small molecule aromatics (Chen and Pignatello, 1997; Peres et al., 2004; Huang et al., 2008; Kang et al., 2002). Chelator-driven Fenton reactions have been described in the literature for demethoxylation and partial breakdown of lignin (Arantes et al, 2009) as well as for breakdown of low MW aromatics (Arantes et al, 2007; Arantes et al, 2007), including the use of DHB with FeCl₃ (Contreras et al 2006). Solubilization of lignin yields polymeric fragments having good dispersive properties which results from suitable reaction conditions, and that this can occur with a minimal amount of the expensive reactant H₂O₂. When a mixture of DHB, FeCl₃, and lignin in water at pH 6 is stirred vigorously for a minimum of several hours prior to adding H₂O₂, the average size of the insoluble lignin particles is substantially reduced such that the solution appears much more homogeneous to the eye. Upon addition of H₂O₂ to the premixed solution of lignin+DHB+FeCl₃ extensive chemical modification of the lignin polymer occurs resulting in a substantial mass of solubilized material.

Preincubation and vigorous mixing of lignin with DHB alone (no FeCl₃) results in much less effective reduction in lignin particle size. This indicates that complexes of DHB/Fe are better for solvating lignin than is DHB alone. Furthermore, addition of H₂O₂ and FeCl₃ following preincubation of lignin with DHB alone results in much less effective lignin solubilization. There is a distinct advantage to using complexes of DHB/FeCl₃ to reduce the particle size and improve the dispersion prior to addition of H₂O₂.

This invention provides a simple way convert insoluble lignin into a water-soluble product that has good dispersant characteristics using a room temperature reaction and dilute solutions of DHB, FeCl₃, and H₂O₂. This invention enables control over the distribution of water-soluble products by controlling the time of reaction, the amount of FeCl₂ or FeCl₃, and the amount of lignin relative to the amount of H₂O₂.

Classic Fenton chemistry includes the following reactions:

Fe(II)+H₂O₂→HO·+Fe(III)+OH−(fast) 1.

Fe(III)+H₂O₂→Fe(II)+HO₂·/O₂·−+H+(slow) 2.

### Biomass

The biomass comprising the lignin can be any biomass disclosed herein. The biomass can be obtained from one or more feedstock, such as softwood feedstock, hardwood feedstock, grass feedstock, and/or agricultural feedstock, or a mixture thereof. In some embodiments, the biomass is a lignocellulosic biomass comprising cellulose, hemicellulose, and lignin in various ratios (depending on the biomass source). The cellulose, hemicellulose, and lignin are held together by covalent and strong hydrogen bonds forming a complex matrix recalcitrant to facile depolymerization. The biomass can also be from any post-production or post-consumer source that comprises lignin and/or lignosulfonate, such as used coffee grounds, spent pulping liquids (red or brown liquor) from sulfite pulping, or a waste stream.

Softwood feedstocks include, but are not limited to, Araucaria (e.g. A. cunninghamii, A. angustifolia, A. araucana); softwood Cedar (e.g. Juniperus virginiana, Thuja plicata, Thuja occidentalis, Chamaecyparis thyoides Callitropsis nootkatensis); Cypress (e.g. Chamaecyparis, Cupressus Taxodium, Cupressus arizonica, Taxodium distichum, Chamaecyparis obtusa, Chamaecyparis lawsoniana, Cupressus semperviren); Rocky Mountain Douglas fir; European Yew; Fir (e.g. Abies balsamea, Abies alba, Abies procera, Abies amabilis); Hemlock (e.g. Tsuga canadensis, Tsuga mertensiana, Tsuga heterophylla); Kauri; Kaya; Larch (e.g. Larix decidua, Larix kaempferi, Larix laricina, Larix occidentalis); Pine (e.g. Pinus nigra, Pinus banksiana, Pinus contorta, Pinus radiata, Pinus ponderosa, Pinus resinosa, Pinus sylvestris, Pinus strobus, Pinus monticola, Pinus lambertiana, Pinus taeda, Pinus palustris, Pinus rigida, Pinus echinata); Redwood; Rimu; Spruce (e.g. Picea abies, Picea mariana, Picea rubens, Picea sitchensis, Picea glauca); Sugi; and combinations/hybrids thereof.

For example, softwood feedstocks which may be used herein include cedar; fir; pine; spruce; and combinations thereof. The softwood feedstocks for the present invention may be selected from loblolly pine (Pinus taeda), radiata pine, jack pine, spruce (e.g., white, interior, black), Douglas fir, Pinus silvestris, Picea abies, and combinations/hybrids thereof. The softwood feedstocks for the present invention may be selected from pine (e.g. Pinus radiata, Pinus taeda); spruce; and combinations/hybrids thereof.

Hardwood feedstocks include, but are not limited to, Acacia; Afzelia; Synsepalum duloificum; Albizia; Alder (e.g. Alnus glutinosa, Alnus rubra); Applewood; Arbutus; Ash (e.g. F. nigra, F. quadrangulata, F. excelsior, F. pennsylvanica lanceolata, F. latifolia, F. profunda, F. americana); Aspen (e.g. P. grandidentata, P. tremula, P. tremuloides); Australian Red Cedar (Toona ciliata); Ayna (Distemonanthus benthamianus); Balsa (Ochroma pyramidale); Basswood (e.g. T. americana, T. heterophylla); Beech (e.g. F. sylvatica, F. grandifolia); Birch; (e.g. Betula populifolia, B. nigra, B. papyrifera, B. lenta, B. alleghaniensis/B. lutea, B. pendula, B. pubescens); Blackbean; Blackwood; Bocote; Boxelder; Boxwood; Brazilwood; Bubing a; Buckeye (e.g. Aesculus hippocastanum, Aesculus glabra, Aesculus flava/Aesculus octandra); Butternut; Catalpa; Chemy (e.g. Prunus serotina, Prunus pennsylvanica, Prunus avium); Crabwood; Chestnut; Coachwood; Cocobolo; Corkwood; Cottonwood (e.g. Populus balsamifera, Populus deltoides, Populus sargentii, Populus heterophylla); Cucumbertree; Dogwood (e.g. Cornus florida, Cornus nuttallii); Ebony (e.g. Diospyros kurzii, Diospyros melanida, Diospyros crassiflora); Elm (e.g. Ulmus americana, Ulmus procera, Ulmus thomasii, Ulmus rubra, Ulmus glabra); Eucalyptus; Greenheart; Grenadilla; Gum (e.g. Nyssa sylvatica, Eucalyptus globulus, Liquidambar styraciflua, Nyssa aquatica); Hickory (e.g. Carya alba, Carya glabra, Carya ovata, Carya laciniosa); Hornbeam; Hophornbeam; Ip6; Iroko; Ironwood (e.g. Bangkirai, Carpinus caroliniana, Casuarina equisetifolia, Choricbangarpia subargentea, Copaifera spp., Eusideroxylon zwageri, Guajacum officinale, Guajacum sanctum, Hopea odorata, Ipe, Krugiodendronferreum, Lyonothamnus lyonii (L. floribundus), Mesua ferrea, Olea spp., Olneya tesota, Ostrya virginiana, Parrotia persica, Tabebuia serratifolia); Jacarandi; Jotoba; Lacewood; Laurel; Limba; Lignum vitae; Locust (e.g. Robinia pseudacacia, Gleditsia triacanthos); Mahogany; Maple (e.g. Acer saccharum, Acer nigrum, Acer negundo, Acer rubrum, Acer saccharinum, Acer pseudoplatanus); Meranti; Mpingo; Oak (e.g. Quercus macrocarpa, Quercus alba, Quercus stellata, Quercus bicolor, Quercus virginiana, Quercus michauxii, Quercus prinus, Quercus muhlenbergii, Quercus chrysolepis, Quercus lyrata, Quercus robur, Quercus petraea, Quercus rubra, Quercus velutina, Quercus laurifolia, Quercus falcata, Quercus nigra, Quercus phellos, Quercus texana); Obeche; Okoume; Oregon Myrtle; California Bay Laurel; Pear; Poplar (e.g. P. balsamifera, P. nigra, Hybrid Poplar (Populusxcanadensis)); Ramin; Red cedar; Rosewood; Sal; Sandalwood; Sassafras; Satinwood; Silky Oak; Silver Wattle; Snakewood; Sourwood; Spanish cedar; American sycamore; Teak; Walnut (e.g. Juglans nigra, Juglans regia); Willow (e.g. Salix nigra, Salix alba); Yellow poplar (Liriodendron tulipifera); Bamboo; Palmwood; and combinations/hybrids thereof.

For example, hardwood feedstocks for the present invention may be selected from Acacia, Aspen, Beech, Eucalyptus, Maple, Birch, Gum, Oak, Poplar, and combinations/hybrids thereof. The hardwood feedstocks for the present invention may be selected from Populus spp. (e.g. Populus tremuloides), Eucalyptus spp. (e.g. Eucalyptus globulus), Acacia spp. (e.g. Acacia dealbata), and combinations thereof.

Grass feedstocks include, but are not limited to, C₄ or C₃ grasses, e.g., Switchgrass, Indiangrass, Big Bluestem, Little Bluestem, Canada Wildrye, Virginia Wildrye, and Goldenrod wildflowers, etc, amongst other species known in the art.

Agricultural feedstocks include, but are not limited to, agricultural byproducts such as husks, stovers, foliage, and the like. Such agricultural byproducts can be derived from crops for human consumption, animal consumption, or other non-consumption purposes. Such crops can be corps such as corn, wheat, sorghum, rice, soybeans, hay, potatoes, cotton, or sugarcane. The feedstock can arise from the harvesting of crops from the following practices: intercropping, mixed intercropping, row cropping, relay cropping, and the like.

In some embodiments, the biomass is an ensiled biomass. In some embodiment, the biomass is ensiled by placing the biomass in an enclosed container or room, such as a silo, or by piling it in a heap covered by an airproof layer, such as a plastic film. The biomass undergoing the ensiling, known as the silage, goes through a bacterial fermentation process resulting in production of volatile fatty acids. In some embodiment, the ensiling comprises adding ensiling agents such as sugars, lactic acid or inoculants. In some embodiments, the ensiled biomass comprises one or more toxic compounds.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

The invention having been described, the following examples are offered to illustrate the subject invention by way of illustration, not by way of limitation.

### Example 1

Presented herein is a method for treating lignin using a room temperature, one step oxidative process to selectively open the aromatic rings and generate carboxylic acid groups. The approach largely avoids depolymerization and results in a water-soluble polyacid that constitutes a valuable product, for example as a dispersant, without need for further upgrading. Polymeric dispersants are used extensively in dyes, paints, concrete, pharmaceuticals, cosmetics, paper and paperboard, ceramics processing, and to inhibit fouling in cooling water systems. This approach uses chelator-mediated Fenton chemistry (e.g., FeCl₃+chelator+H₂O₂). The Fenton reaction, reaction of hydrogen peroxide and ferrous salt, is used to treat industrial waste and organic contaminants in groundwater and has been employed in biomass pretreatment strategies. Use of an Fe chelator in the Fenton system leads to substantially higher yields of solubilized polyacid product per oxidant (H₂O₂) consumed. It is also shown that the amount of aromatic ring opening can be controlled by the reaction conditions. By controlling the extent of ring opening, the relative amounts of hydrophobic and charged groups can be tailored to produce polyacids with properties optimized for specific applications. The economic feasibility of this process depends on maximizing the yield of solubilized lignin material per amount of H₂O₂ consumed and also minimizing or eliminating separation steps. The material solubilized by this reaction behaves as an effective dispersant.

Trial 1 is performed as follows: 20 g AT, 20 g 10 mM FeCl₃+DHB, 20 mL H₂O (60 mL total). FeCl₃ hexahydrate is used (MW=270.3 g/mol). DHB is dihydroxybenzene (pyrocatechol; MW=110.1 g/mol). AT=indulin AT lignin. The following reactions are run:
Reaction 1: 3.72 mL H₂O₂ (35%) (54 mg FeCl₃, 22 mg DHB, 11 g AT).
Reaction 2: 3.72×2=7.44 mL H₂O₂.
Reaction 3: 3.72×2=7.44 mL H₂O₂.
Reaction 4: 3.72×2=7.44 mL H₂O₂.
Reaction 5: 3.72×2=7.44 mL H₂O₂.
Reaction 6: 3.72×2=7.44 mL H₂O₂.
Reaction 7: 3.72×2=7.44 mL H₂O₂.
Reaction 8: 3.72×2=7.44 mL H₂O₂.
Reaction 9: 3.72×2=7.44 mL H₂O₂.
(60 mL+11 g AT+63.2 mL H₂O₂=134 mL total, 31 g AT/134=0.23, 23% solids)
   added 54 mg FeCl₃, 22 mg DHB, heated 1 week at 50° C., adjust pH to 6
   added 44 mg DHB, overnight, adjust pH to 6
   added 108 mg FeCl₃, 44 mg DHB, overnight, adjust pH to 6
   added 108 mg FeCl₃, 44 mg DHB, overnight, adjust pH to 6
   added 88 mg DHB, 2 days, 215 mg FeCl₃, 88 mg DHB, overnight, adjust pH to 6.
Total: 590 mg FeCl₃, 370 mg DHB, 63.3 mL H₂O₂ (35%)×0.35=22.2 g H₂O₂ (pure basis).

Trial 2 is performed as follows: 20 g AT, 40 g 10 mM FeCl₃+DHB (108 mg FeCl₃, 44 mg DHB) (60 mL initial volume). The following reactions are run:
Reaction 1: 4 mL H₂O₂ (35%).
Reaction 2: 4 mL H₂O₂.
Reaction 3: 4 mL H₂O₂.
Reaction 4: 4 mL H₂O₂.
Reaction 5: 4 mL H₂O₂.
Reaction 6: 4 mL H₂O₂.
Reaction 7: 4 mL H₂O₂.
Reaction 8: 8 mL H₂O₂.
Reaction 9: 8 mL H₂O₂.
Reaction 10: 8 mL H₂O₂.
   added 108 mg FeCl₃, 44 mg DHB, overnight, adjust pH to 6
   added 108 mg FeCl₃, 44 mg DHB
Reaction 11: 8 mL H₂O₂.
   added 108 mg FeCl₃, 44 mg DHB, overnight, adjust pH to 6
   added 108 mg FeCl₃, 44 mg DHB, overnight, adjust pH to 6
   added 88 mg DHB, 3 days, adjust pH to 6 each day
   added 215 mg FeCl₃, 88 mg DHB, 2 days, adjust pH to 7.
Total: 756 mg FeCl₃, 396 mg DHB, 60 mL H₂O₂ (35%)×0.35=21 g H₂O₂ (pure basis). (60 mL initial+11 g AT+60 mL H₂O₂ (35%)=131 mL total volume, 31 g AT/131 g=0.24, 24% solids).

Trial 3 is performed as follows: 20 g AT, 750 mg 10 mM FeCl₃ and 400 mg DHB in 40 g H₂O at pH 6.0 (60 mL initial volume). The following reactions are run:
Reaction 1: 8 mL H₂O₂ (35%).
   added 10 g AT
Reaction 2: 8 mL H₂O₂.
Reaction 3: 8 mL H₂O₂.
Reaction 4: 16 mL H₂O₂.
Reaction 5: 16 mL H₂O₂.
   added 25 mg DHB, overnight
   added 51 mg DHB, overnight
   added 50 mg DHB, overnight
   added 100 mg DHB, overnight

Added H₂O to increase mass to 135 g total (30 g lignin/135 g=0.22, 22% solid).

Trial 4 is performed as follows: 20 g AT, 1.35 g Fe(SO₄)₃×5 H₂O (MW=489.96 g/mol) and 400 mg DHB in 40 g H₂O at pH 6.0 (60 mL total). The following reactions are run:
Reaction 1: 8 mL H₂O₂ (35%).
   added 10 g AT
Reaction 2: 8 mL H₂O₂.
Reaction 3: 8 mL H₂O₂.
Reaction 4: 8 mL H₂O₂.
Reaction 5: 8 mL H₂O₂.
Reaction 6: 8 mL H₂O₂.
Reaction 7: 8 mL H₂O₂.
Total: 1.35 mg Fe(SO₄)₃×5 H₂O, 400 mg DHB, 56 mL H₂O₂ (35%)×0.35=19.6 g H₂O₂ (pure basis) (30 g lignin/131 g=0.22, 23% solids).

### Example 2

Lignosulfonate DP-4397 is a gift from Borregaard. FeCl₃ heptahydrate and Fe₂(SO₄)₃ and DHB from Aldrich. H₂O₂ (33-37%) from Fisher.

Results show that when this CMF reaction is performed at high iron concentration (over than 10 mM) it results in a very strong increase in the MW of lignosulfonate. Increasing the MW of lignosulfonate will be beneficial for some commercial applications, including its use to disperse cement particles in the manufacture of concrete. Molecular weight increase also occurs with other lignins using the same method.

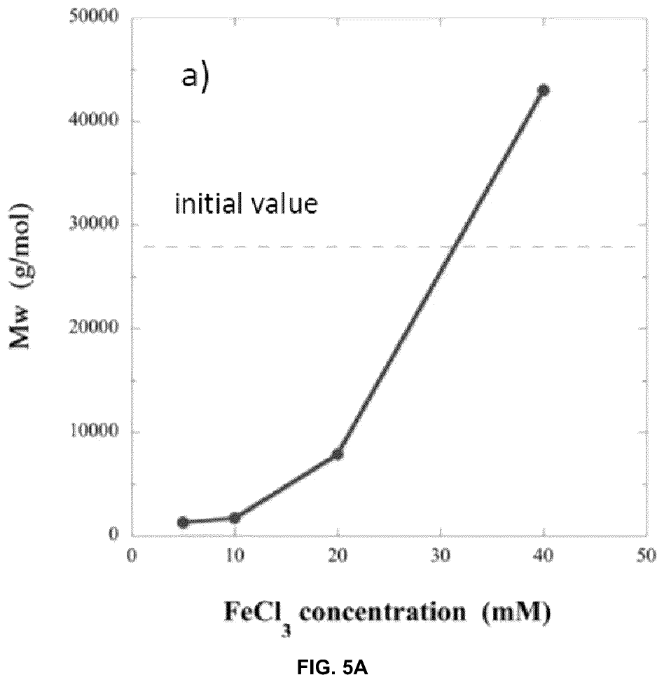

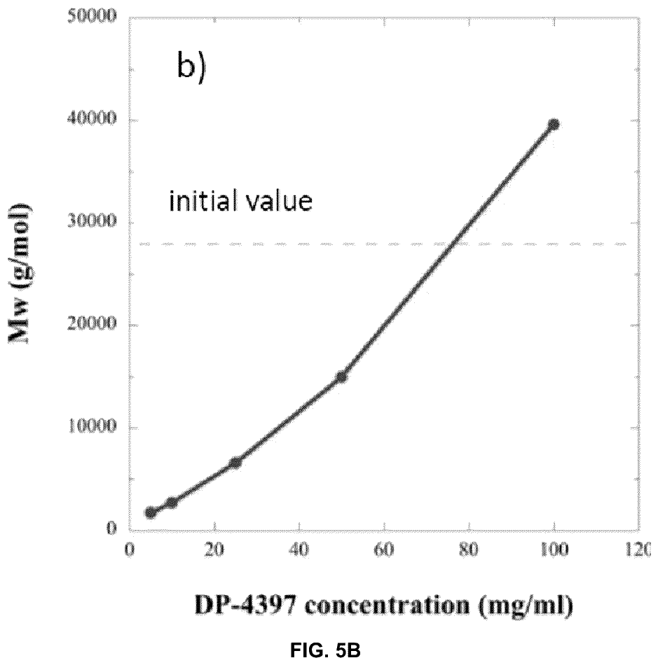

CMF reactions are performed as a function of [Fe] and [LS]. The molecular weight distribution before and after reaction is measured using aqueous phase GPC at with 1 mM phosphate buffer at pH 9 using polystyrene sulfonate standards for calibration. The weight averaged molecular weight (Mw) of the initial sample is 28,000 g/mol. The Mw after reaction varies strongly with both [Fe] and [LS], as shown in FIGS. 5A and 5B. At low [Fe] and [LS]depolymerization occurs and the final Mw values are much lower than the initial value.

However, at high [Fe] and [LS], Mw values that are much higher than the initial value can be obtained. In these tests iron is used in the form of ferric chloride, but any salt of Fe(II) or Fe(III) can be used. Iron sulfate is very inexpensive and so would be a good choice for this reaction in an industrial setting.

Method A is the CMF method described in the example of U.S. Patent Application Publication No. 2019/0002490 (Michael Kent). Method B is a reaction having the conditions: 10 mM FeCl₃-DHB complex, 0.5% H₂O₂, and 5 mg/mL lignin.

For FIG. 2, as received Indulin AT has Mw=2,700. After treating Indulin AT with Method A, the MW distribution is slightly reduced due to some low MW species generated. Upon treating Indulin AT with 46 mM Fe the Mw increased to 9,800 g/mol.

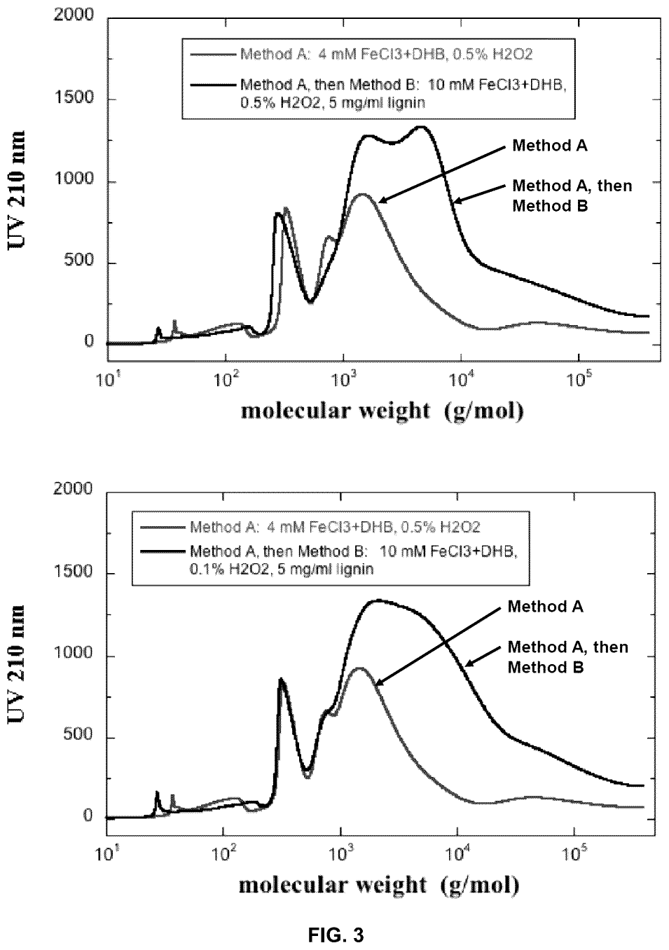

For FIG. 3, when Method A is followed with a Method B treatment at higher Fe concentration the MW increases substantially. For the top panel, Method B is a reaction having the conditions: 10 mM FeCl₃-DHB complex, 0.5% H₂O₂, and 5 mg/mL lignin. For the bottom panel, Method B is a reaction having the conditions: 10 mM FeCl₃-DHB complex, 0.1% H₂O₂, and 5 mg/mL lignin.

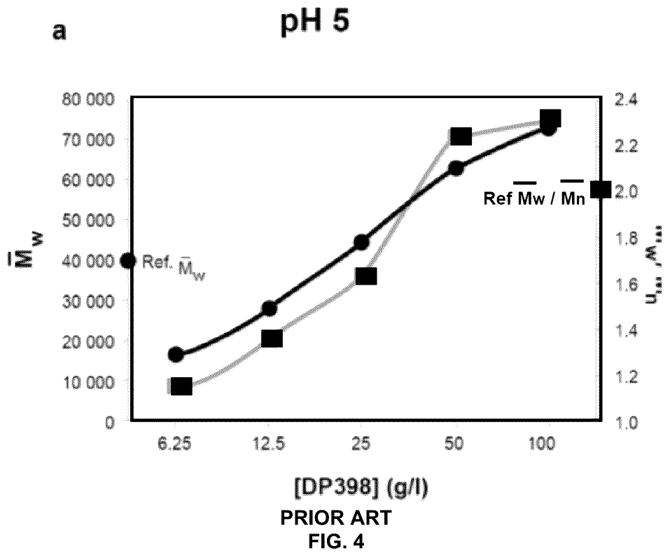

FIG. 4 shows lignosulfonates and Fenton reaction prior work by Areskogh and Henriksson (Nordic Pulp and Paper Research Journal, 26:90, 2011). MW is altered by lignin concentration.

The results obtained herein show that the effect of Mw increase is much stronger with increasing Fe concentration, and that these effects are also true for lignin as well as with lignosulfonate. This allows the MW to be increased to much higher values.

For FIGS. 5A and 5B, it can be seen that when the FeCl₃ concentration is increased beyond about 30 mM, the MW of lignosulfonate increases from its original MW, and when the lignosulfonate concentration is increased beyond about 80 mg/mL, the MW of lignosulfonate increases from its original MW. FIG. 5A shows that a very strong increase in molecular weight (MW) occurs for higher Fe concentrations for lignosulfonate. It is also observed an increase in Mw with Fe concentration for kraft lignin and corn stover lignin from an alkaline process.

FIG. 6 shows the Fourier-transform infrared spectroscopy (FTIR) data from polyacid product after CMF.

With suitable reaction conditions the average molecular weight increases substantially. The ability to increase Mw with the reaction conditions. Run 6 was at the very limit of processability for the conditions set. For example, the initial lignin loading can be less than or equal to about 25%. The initial Fe(II) concentration can be equal to, or less than, about 40 mM Fe(II). The initial DHB concentration can should be equal to, or less than, about 45 mM. H₂O₂ can be added at a rate that is less than or equal to about 0.2% (by weight) every about 15 minutes. That means for about 200 ml volume the H₂O₂ can be added at a rate that is less than or equal to about 0.4 ml (pure basis) per about 15 min.

For reaction 5: The reactor was initially charged with 20 g Indulin AT, 0.767 g Fe(II)sulfate heptahydrate, 0.40 g dihydroxybenzene, 39 ml water at room temperature and the pH was adjusted to 6.0. Then 8 ml of 35% H₂O₂ were added 1 ml at a time at ˜2 min intervals with stirring. During the reaction the pH decreased. The H₂O₂ level was monitored until 90% of the H₂O₂ had dissipated. Then the pH was increased to 6.0 with 50% NaOH and 10 g of Indulin AT were added to the reaction mixture and after mixing, 8 ml of 35% H₂O₂ were added 1 ml at a time at about 2 min intervals with stirring. No further lignin was added from this point forward. Then 8 ml of 35% H₂O₂ were added 1 ml at a time at ˜2 min intervals. The F1202 level was monitored until >90% of the H₂O₂ had dissipated and then the pH was increased to 6.0 with 50% NaOH. This process was repeated until 48 ml of 35% H₂O₂ were added (6 total additions of 8 ml). To dissipate the final aliquot of H₂O₂, the reaction was heated to 45 C and an additional 200 mg of DHB were added.

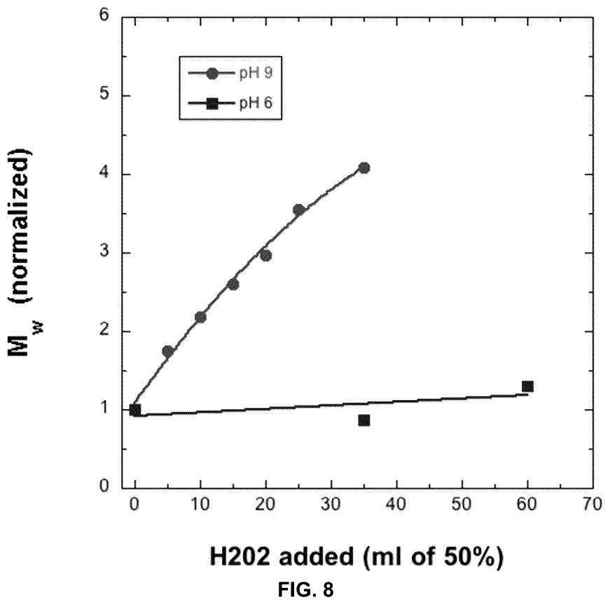

FIG. 7 shows increasing the volume of H₂O₂ added increases the amount of ring opening. FIG. 8 shows pH affects how increasing the volume of H₂O₂ added increases the molecule weight of the lignin sample tested. CMF opens aromatic rings, adds COOH functionality and alters the molecular weight.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A method to convert water-insoluble lignin into water-soluble polyacid, the method comprising: (a) contacting a chelator/Fe complex with a water-insoluble lignin to produce a reaction mixture, (b) introducing an oxidizing agent to the reaction mixture, (c) incubating the reaction mixture for a suitable period of time, (d) introducing further water-insoluble lignin to the reaction mixture during step (c); (e) introducing further oxidizing agent to the reaction mixture incubating step (c); and (f) optionally repeating step (d) and/or step (e) one or more times; such that at least about 90% of the water-insoluble lignin in the reaction mixture is converted into a water-soluble polyacid by the opening of at least one aromatic ring in each water-insoluble lignin.

2. The method of claim 1, the method further comprises: contacting a Fe salt and a chelator to form the chelator/Fe complex.

3. The method of claim 2, the method further comprises: the contacting a Fe salt and a chelator step occurs prior to concurrently with contacting step (a).

4. The method of claim 1, wherein the Fe salt is any Fe(II) salt or Fe(III) salt.

5. The method of claim 4, wherein the Fe salt is FeX₃, wherein X is any halide, Fe₂(SO₄)₃, Fe(NO₃)₃, iron (II) perchlorate (Fe(ClO₄)₂), iron(II) phosphate (FePO₄), iron(III) pyrophosphate (Fe₄(P₂O₇)₃), iron(II) pyrophosphate, iron(II) sulfate (FeSO₄), ammonium iron(II) sulfate, iron(II) bromide, iron(III) bromide, iron(II) chloride, iron(III) chloride, iron(II) fluoride, iron(III) fluoride, iron(III) nitrate, iron(II) oxalate, iron(III) oxalate, or a hydrate thereof, or a mixture thereof.

6. The method of claim 5, wherein X is F, Cl, Br, or I.

7. The method of claim 1, wherein the chelator is any chelator that can chelate Fe to facilitate the reduction of Fe(III) to Fe(II).

8. The method of claim 7, wherein the chelator is 1,2-dihydroxybenzene (DHB), 2,3-dihydroxybenzoic acid (DHBA), pyrogallol, or a mixture thereof.

9. The method of claim 1, wherein the method lacks a concentration step and/or separating step.

10. The method of claim 1, wherein the water-insoluble lignin is part of a solid component that is equal to or more than about 20% by weight of the reaction mixture.

11. The method of claim 1, wherein the introducing step (d), introducing step (e), and/or repeating step (f) are continuous or semi-continuous.

12. The method of claim 1, wherein the method further comprises: (g) introducing a base to the reaction mixture to adjust the pH of the reaction mixture to about pH 3.0 to 6.0, and (h) optionally repeating step (g) one or more times.

13. The method of claim 1, wherein the method further comprises: (i) heating the reaction mixture to a temperature of about 40° C. to 60° C.

14. The method of claim 1, wherein the introducing step (b) and/or introducing step (e) comprise bubbling a gas composition comprising O₂ into the reaction mixture.

15. The method of claim 1, wherein the oxidizing agent is H₂O₂ or molecular oxygen (02), or both.

16. A method for providing nutrients to a plant or plant substrate, the method comprising: introducing a mixture of modified lignin comprising a lignin with at least one aromatic ring opened to form a polyacid to soil, sand, or substrate for plants, or mixture thereof, to form an enhanced substrate composition.

17. The method of claim 16, wherein the substrate for plants comprises used coffee grounds.

18. A method for increasing the molecular weight (MW) of lignosulfonate and/or lignin, the method comprising: (a) contacting a chelator/Fe complex with a lignosulfonate and/or lignin or a mixture thereof, to produce a reaction mixture, (b) incubating the reaction mixture for a suitable period of time, and (c) optionally introducing an oxidizing agent to the reaction mixture; such that the average molecular weight of the lignosulfonate and/or lignin in the reaction mixture is increased.

19. The method of claim 18, wherein the Fe concentration added to the reaction mixture has a concentration equal to or higher than about 10 mM, 15 mM, 20 mM, 25 mM, 30 mM, 35 mM, 40 mM, 45 mM, or 50 mM, or having a value within any two preceding values.

20. A mixture of modified lignin, having (a) one or more water-insoluble lignin converted into a water-soluble polyacid by the opening of at least one aromatic ring in each water-insoluble lignin, and or (b) increased average MW of lignosulfate or lignin, or a mixture thereof.
